(19) United States
(12) Patent Application Publication
(10) Pub. No.: US 2024/0230517 A1
(43) Pub. Date: Jul. 11, 2024

(54) ADDITIVELY MANUFACTURED REFLECTIVE SAMPLE HOLDER FOR NIR- AND RAMAN-SPECTROPHOTOMETRY

(71) Applicant: Ayna Analytics GmbH, Kleinmachnow (DE)

(72) Inventors: Laura RODRÍGUEZ GARCÍA, Potsdam (DE); David MAINKA, Potsdam (DE)

(73) Assignee: Ayna Analytics GmbH, Kleinmachnow (DE)

(21) Appl. No.: 18/682,695

(22) PCT Filed: Jul. 8, 2022
(86) PCT No.: PCT/EP2022/069161

§ 371 Date: Feb. 9, 2024

(30) Foreign Application Priority Data
Jul. 9, 2021 (WO) PCT/EP2021/069213

(51) Int. Cl. G01N 21/03; B22C 7/02; B33Y 10/00; B33Y 80/00; G01N 21/359; G01N 21/47; G01N 21/65

(52) U.S. Cl. CPC G01N 21/0303; B22C 7/02; G01N 21/359; B33Y 10/00; B33Y 80/00; G01N 2021/4761; G01N 2021/651

(57) ABSTRACT

A sample holder and method is disclosed. In one example, the sample holder is for spectrophotometric measurements of a sample using a transflection technique. The sample holder comprises a sample receiving chamber comprising a diffusive mirror, wherein a curvature of the diffusive mirror is adapted to a curvature of a surface of the sample and/or adapted to a curvature of a surface of a container comprising the sample. Further, a sample holder for spectrophotometric measurements of a sample using a transmission technique is disclosed. The sample holder comprises a hollow light guiding channel, wherein an inner wall of the hollow light guiding channel is covered by a smooth reflective coating and is configured to encase at least partially a tubular part of the sample or of a container containing the sample along a circumferential direction of the tubular part of the sample or of the container.

### FIELD AND BACKGROUND

The present invention relates to any set-up directed towards spectroscopic measurements based on transflection of a light, particularly to a sample receiving chamber comprising a reflective or mirror surface configured for such a set-up.

Transflection is an extension of the transmission technique. When a mirror is placed behind a sample, the light transmitted through the sample is reflected back through the sample and into a diffuse reflectance probe used as detector. Thus, transflection measures a combination of transmission and reflection. This technique is applicable, for example, to emulsions, suspensions, gels, turbid liquids, and thus to various pharmaceutical intermediates, formulations, and products, as well as to crop products, food, feed, and hence, useful in related technologies.

In particular, transflective near-infrared spectroscopy allows the identification and/or quantification of an active pharmaceutical ingredient (API), an excipient and/or the detection of falsification and/or substandard quality of a product or impurity of an API, as well as the quantification/detection/verification of the physical properties (agglomeration, particle size, etc.) of these components, whether they are in a liquid state in a sterile package or even in a bulk pile of dry particles, e.g. dried medicinal plants. However, fruits, e.g. berries, cherries, or other plants or foods can also be analyzed without compromising their integrity. Thus, the proposed sample holder can also be used to determine an ingredient or a harvest date. All in all, the proposed sample holder as well as the proposed method using it can thus also be assigned to non-destructive testing.

Incorrect production or incorrect storage of pharmaceutical products can result in a loss of the intended effect, or may even harm the organism to which the pharmaceutical products are applied.

Therefore, quality and/or identity control of pharmaceutical products before their further use, e.g. immediately before application to a patient or immediately before their admixture to an intermediate formulation is of utmost importance.

Typically, a sample of a batch of the pharmaceutical product is taken and analysed resulting in the destruction of the sample/batch. As the batch number regarding individually produced infusion bags, pumps or syringes is often n=1, it is not possible to assess the quality of the compounding before the batch release. Moreover, those approaches often require an analytical laboratory as well as trained, highly specialized personnel to evaluate analysis results, e.g. spectra or chromatograms.

### BRIEF SUMMARY

In view of the above and in order to not compromise the integrity and thus sterility of the original solution and/or its container, a reflective sample holder, a method of its manufacture, and a method of its use are suggested.

Particularly, by measuring a transflection of a measuring light beam (sample beam) of a NIR-spectrophotometer or a Raman-spectrophotometer which is directed through the sample the gathered information can be used to identify or even quantify chemical components in the sample and/or to analyze physical properties of the sample. Such measurements can be made simultaneously with respect to different analytes, their parameters and/or properties.

According to the present embodiments, sample holders are provided that are specially configured by a shape of their sample receiving chamber, the surface structure of a diffusive mirror surface of the sample receiving chamber, and a reflectivity of the diffusive mirror surface for characterizing a sample, e.g. pharmaceutical products by NIR spectroscopy or Raman spectroscopy via transflectance or even via transmission. The sample holders enable an overall higher quality and an overall higher reproducibility of the measurement results.

The NIR or Raman instrument, the sample, and the suggested sample receiving chamber comprising the diffusive mirror are positioned with respect to each other to ensure that high quality measurement results are achieved.

Surprisingly, additive manufacturing techniques could be adapted for manufacturing of different sample holders comprising a sample receiving chamber for pharmaceutical products, formulations or other samples, each sample holder comprising at least a reflective surface that is either partly or fully covered with a diffusive mirror surface which is used for a transflection measurement of the sample.

Further, by using the suggested sample holder comprising the sample receiving chamber encompassing a diffusive mirror and/or a reflective coating, a new method for characterization, e.g. identification, verification of conformity, semi-quantification and quantification of medicinal caffeine containing solutions, with respect to their content of caffeine or other APIs, has been developed. The caffeine solutions can be sterile or non-sterile. Typically, a syringe is used as primary packaging of the caffeine solution. These medicinal caffeine solutions are, for example, used in the treatment of apnea for premature infants. Using the suggested sample holder allows for a simpler, faster, and cheaper characterization of various APIs which is as reliable as previously used methods. Furthermore, the use of the sample receiving chamber guarantees that the diffusive mirror will not have direct contact to a sample and therefore will not require cleansing.

### BRIEF DESCRIPTION OF THE DRAWINGS

FIG. 1 shows a vertical cross-section of an embodiment of a one piece cylindric-shaped sample holder which is configured for measuring, e.g., samples comprising dried herbs or flower buds held in a transparent container, e.g. a quartz glass baker.

FIG. 2 shows a vertical cross-section of an embodiment of a two-piece sample holder which is configured for measuring, e.g., a liquid sample held in a cuvette, e.g. a quartz glass baker.

FIG. 3 shows a cross-section of another embodiment of a two-piece sample holder adapted for measuring, e.g., a liquid sample held in a cuvette.

FIG. 4 shows a cross-section of an embodiment of a sample holder configured for transflection measurements with a capsule or a dragée.

FIG. 5 shows sections which are used for the generation of a surface structure of a diffusive mirror.

FIG. 6 shows several planar surface structures of a diffusive mirror that can be generated from the sections shown in FIG. 5.

FIG. 7 shows the curved surface structure of a diffusive mirror as well as a reflective surface without such a surface structure.

FIG. 8 shows the cross section of a reflective sample holder for measuring syringes with the transflection technique.

FIG. 9 shows the cross section of a reflective sample holder for measuring syringes with the transmission technique.

FIG. 10 shows an NIR-spectrum, obtained with the transflection technique, that contains measurements of syringes that hold medicinal caffeine solutions.

FIG. 11 shows the first derivation of a section of the NIR-spectrum, obtained with the transflection technique, shown in FIG. 10, that contains measurements of syringes that hold medicinal caffeine solutions.

FIG. 12 shows an NIR-spectrum, obtained with the transmission technique, that contains measurements of syringes that hold medicinal caffeine solutions.

FIG. 13 shows the first derivation of a section of the NIR-spectrum, obtained with the transmission technique, shown in FIG. 12, that contains measurements of syringes that hold medicinal caffeine solutions.

A full and enabling disclosure of the present invention, including the best mode thereof, to one of ordinary skill in the art, is set forth more particularly in the remainder of the description, including reference to the accompanying figures.

In the following detailed description, reference is made to the accompanying figures, which form a part hereof, and in which are shown by way of illustration specific embodiments and features of the invention. It is to be understood that other embodiments may be utilized and structural or logical changes may be made without departing from the scope of the present invention.

The following detailed description, therefore, is not to be taken in a limiting sense, and the scope of the present invention is defined by the appended claims.

### DETAILED DESCRIPTION

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification (above and below) and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “additive manufacturing” as used herein, describes a technology which different to subtractive techniques encompasses techniques also known as fused deposition modeling (FDM), powder bed fusion (LPBF) technique or a variation thereof, like Selective Laser Melting (SLM), Selective Laser Sintering (SLS), Electron Beam Melting (EBM) and Direct Metal Laser Sintering (DMLS), which are typically applied to a layer or a bed comprising distinct particles or a powder comprising a metal, a ceramic and/or a polymer; a binder jetting or a material jetting technique used with particles comprising a polymer, a ceramic, or a metal or an alloy; a material extrusion technique in which a material is drawn through an optionally heated nozzle, comprising a continuous deposition of the extruded material; and a wire arc melting technique, comprising a metal melting in an electric arc. Further, lost wax casting is also considered as an additive manufacturing techniques Furthermore, injection molding is herein also considered to be an additive manufacturing technique. Accordingly, a technique of producing the proposed reflective sample holder comprising the sample receiving chamber comprises at least one of the mentioned additive manufacturing techniques or a combination of mentioned ones. Advantageously, additive manufacturing is usually very flexible and allows easy adaptation of, e.g., size, shape, and surface structure of components of the suggested sample holder, particularly of the sample receiving chamber it comprises of, and/or the mirror surface thereof or therein.

At least the surface of the sample receiving chamber is either partly of fully covered by a reflective surface and comprises the mentioned diffusive mirror and/or the reflective coating. Reflective materials and corresponding deposition techniques may be selected from chemical vapor deposition techniques (CVD), physical vapor deposition techniques (PVD), vacuum deposition techniques, plating (electroless and galvanic), and atomic layer deposition (ALD), to name a few.

Advantageously the reflective material is gold, steel, aluminum or any other NIR-reflective material, e.g. Teflon, or an alloy that contains at least one of these materials. The favorable wavenumber ranges of the measurement light beam, i.e. sample beam, are 4,000-12,500 cm⁻¹ corresponding to a wavelength range from 800 nm through 2.5 μm.

According to typical embodiments a surface of the sample holder which is directed towards the sample is reflective for NIR. The sample holder, particularly its sample receiving chamber encases the sample as a whole or at least along a circumferential direction of a tubular part of the sample or of the container which protects the sample against contamination.

The reflective surface described may result in an integrating sphere—even though the shape of the sample-receiving chamber may differ from an ideal sphere, it may be referred to as an integrating sphere (Ulbricht sphere).

The proposed reflective sample holder, especially its sample receiving chamber is configured by its shape, its size, its reflective surface, the material used for the reflective surface, the diffusive mirror which can partly or fully cover the reflective surface and the geometry and/or shape of the surface of the diffusive mirror for spectrophotometric measurements of the mentioned above samples, e.g. pharmaceutical formulations, their components, and products using transflective NIR spectrophotometry and/or transflective Raman spectrophotometry, regardless of their shape, size, or consistency, e.g., viscosity.

The geometry and/or shape of the surface of the diffusive mirror is configured by a planar, a curved or any other surface which comprises geometrical bodies such as pyramids, or inclined distinct surfaces, such as triangles (e.g. in the case of these pyramids). These geometrical bodies can be arranged adjacent to each other, i.e. side by side or with distances to each other and can form several adjacent rows which are either arranged side by side or with equal or gradually varying distances to each other. The result can be, for example, parametric geometries. Those surfaces can be polished, partly polished or non-polished. The described configurations determine the reflectivity of the diffusive mirror and therefore the overall reflectivity of the reflective sample holder, especially of its sample receiving chamber (SRC). Typically, the resulting corrugated surface is coated with a reflective layer, e.g. with a gold layer.

For practical reasons, the herein described reflective sample holders are compared by measure experiments to commonly commercially available reflective gold mirrors with a similar high reflectivity. Importantly, the commonly available reflective gold mirrors are limited to flat, i.e. planar surfaces. For these and other reasons the herein suggested reflective sample holders enable an overall higher quality and an overall higher reproducibility of measurement results. Particularly, the achieved technical effects in regard to the achieved measurement results are a lower signal to noise ratio, a higher spectral resolution and therefore, an improved detection limit (limit of detection/LOD) and sensitivity and, furthermore, an improved reproducibility compared to commonly available reflective gold mirrors of similar reflectivity.

The term sample as used herein, comprises any natural product (plant extracts, dried plant matter and so on), any pharmaceutical formulation, any liquid, any solution, any dispersion, any solid (such as a powder, a lyophilizate and so on), any two-phased-system that is or is not partly or fully enclosed by a container. Examples for such a container are syringes, infusion bags, vials, bottles, cuvettes, blisters or any other container. The primary container can be partially or fully enclosed by a second container.

The term “a semi-solid” as used herein, comprises a gel, hydrogel, a paste or a lotion (of higher viscosity in comparison to usual physiological (aqueous) solutions and therefore mostly a two-phased-system, solid/liquid or liquid/liquid). The term is used in correspondence to its common understanding by the skilled person in pharmaceutical technology and/or food technology.

Further it is noted, that the term “solution” as used therein, is not restricted to aqueous solutions, but relates also to other solvents, e.g. oils. Hence, liquid compositions which can be measured using the suggested reflective sample holder may comprise solutions and dispersions, for example, consist of a multicomponent/multiphase system (foam, emulsion, aerosol). Solutions can be sterile or non-sterile.

As to the pharmaceutical formulations comprising the soft or hard gelatin capsule, the dragée, the suppository, the tablet, or the film-coated tablet which is characterized using the reflective sample holder, they may comprise a liquid medium and a dissolved or dispersed therein pharmaceutically active ingredient (API). Thus, they may comprise the API and a liquid excipient. However, the excipient may also be a solid or comprise solid particles.

For the purpose of this application, the term “pharmaceutical formulation” intends to describe any pharmaceutical dosage form known to those skilled in the art for transporting a pharmaceutically active compound into the human or animal body in order to achieve its desired therapeutic and/or diagnostic effects. Typically, pharmaceutical dosage forms comprise a mixture of (a) drug component(s), i.e. pharmaceutically active ingredient(s), and nondrug components (i.e excipients). In general, these pharmaceutical dosage forms can be categorized by different aspects, e.g. their route of administration, (e.g. oral, inhalational, parenteral, topical administration and more specifically ophthalmic drug administration) or their physical appearance (e.g. solid, semi-solid, liquid, gaseous). For the purpose of this application, particularly those solid, semi-solid or liquid dosage forms are used, which can be administered topically, via parenteral injection or orally. For instance, such dosage forms comprise ointments, creams, gels, lotions, dispersions, granulates, solutions or sterile solutions or injection solutions or infusion solutions, soft or hard gelatin capsules, a dragée, a suppository, a tablet, or a film-coated tablet which is meant to be a non-exhaustive list of possible dosage forms.

According to an embodiment that can be combined with any of the other embodiments described herein, the pharmaceutical formulation comprises an intermediate composition. The concentration of the intermediate composition may be from 0.1% w/w to 99.9% w/w, particularly from 1% w/w to 99% w/w, particularly from 2.5% w/w to 90% w/w, particularly from 5% w/w to 80% w/w, more particularly from 10% w/w to 60% w/w, more particularly from 15% w/w to 40% w/w, based on the total weight of the pharmaceutical formulation.

Furthermore, the concentration of the intermediate composition can be from 10% w/w to 45% w/w, particularly from 20% w/w to 40% w/w, more particularly from 30% w/w to 38% w/w, based on the total weight of the pharmaceutical formulation. Also, the concentration of the intermediate composition can be from 1% w/w to 30% w/w, particularly from 5% w/w to 25% w/w, more particularly from 10% w/w to 20% w/w, based on the total weight of the pharmaceutical formulation. Also, the concentration of the intermediate composition may be from 0.1% w/w to 15% w/w, particularly from 1% w/w to 10% w/w, more particularly from 2% w/w to 5% w/w, based on the total weight of the pharmaceutical formulation.

According to an embodiment that can be combined with any of the other embodiments described herein, the pharmaceutical composition further comprises a liquid medium.

According to an embodiment which can be combined with any of the other embodiments described herein, the liquid medium in the sample is selected from an aqueous solution, such as phosphate buffer saline (PBS), water, such as aqua ad injectabilia, a glycerol, or oils such as hemp oil, castor oil, clove oil, cassia oil, almond oil, corn oil, Arachis oil, peanut oil, cottonseed oil, safflower oil, maize oil, linseed oil, rapeseed oil, soybean oil, caraway oil, rosemary oil, peanut oil, peppermint oil, sunflower oil, eucalyptus oil, olive oil, Mentha oil, peppermint oil, eucalyptus oil, bergamot oil, anise oil, fennel oil, or rose oil. These liquid media can be used alone or in any combination of two or more kinds thereof. The concentration of the liquid medium may be from 1% w/w to 99.9% w/w, particularly from 5% w/w to 95% w/w, particularly from 10% w/w to 90% w/w, particularly from 20% w/w to 80% w/w, more particularly from 30% w/w to 70% w/w, based on the total weight of the pharmaceutical formulation.

According to a particular embodiment, the pharmaceutical component characterized for its pharmaceutically important constituents using the proposed sample receiving chamber is medicinal caffeine solution. Medicinal caffeine solution is used in the treatment of apnea in premature infants. However, such solutions have to be sterile and non-destructive analytical methods that can verify the quality of manufactured or stored medicinal caffeine solutions are so far not available. All commonly available analytical methods either destroy the sample or risk contamination of the sample and therefore risk the loss of sterility of the sample. The main difficulty is to analyze the medicinal caffeine solution while it is still contained in the primary packaging, for example in a syringe. The syringe, however, makes analysis using currently available methods of the held solution impossible, because of its shape, the material it consists of and the thickness of the materials. Characterization, e.g., identification, verification of conformity, semi-quantification and quantification of caffeine in medicinal caffeine solution is possible with the use of the suggested reflective sample holder comprising the sample receiving chamber.

Also, the concentration of the medicinal caffeine solution can be from 0.05% w/w to 30% w/w, particularly from 0.25% w/w to 15% w/w, more particularly from 0.5% w/w to 1.5% w/w of liquid medium, based on the total weight of the pharmaceutical formulation.

According to a particular embodiment, the pharmaceutical component characterized for its pharmaceutically important constituents using the proposed sample receiving chamber is cannabis extract. The extract from cannabis can be contained in any container, more specifically in vials or syringes. So far, it has not been possible to identify or quantify the content of e.g. cannabidiol (CBD) and tetrahydrocannabinol (THC) in extracts from cannabis in medicinal cannabis preparations in a simple and fast way. One technique used to date is HPLC, which requires a dedicated laboratory environment and highly skilled personnel. Other substances that can be reliably detected with the proposed reflective sample holder using, e.g., NIR spectroscopy, in addition to CBD and THC as the main cannabinoids, are: cannabidiol Acid (CBDA), tetrahydrocannabinolic Acid (THCA), cannabinol (CBN), cannabigerol (CBG), cannabigerolic acid (CBGA), cannabidivar (CBCV), cannabichromen (CBC), cannabicyclol (CBL), cannabielsoin (CBE), cannabinodiol (CBND), cannabitriol (CBTL), cannabidivarin (CBDV) and tetrahydrocannabivarin (THCV).

Also, the concentration of the liquid medium can be from 0.05% w/w to 99.9% w/w, particularly from 0.5% w/w to 50% w/w, more particularly from 0.75% w/w to 20% w/w of liquid medium, more particularly from 1% w/w to 10% w/w of liquid medium, based on the total weight of the pharmaceutical formulation.

According to an embodiment that can be combined with any of the other embodiments described herein, the pharmaceutical formulation mentioned above is a dispersion comprising the pharmaceutical formulation as dispersed phase, and the liquid medium as dispersant. Further, the dispersed phase may be a colloidal dispersed phase. For the purpose of this application, the term “colloidal dispersed phase” in relation to the pharmaceutical formulation means that the dispersed phase has a particle size of from 1 μm to 500 μm, particularly of from 10 μm to 300 μm, more particularly of from 50 μm to 200 μm.

According to an embodiment that can be combined with any of the other embodiments described herein, the dispersion is a gel, a suspension, a foam or an emulsion.

Generally, a reflective sample holder for spectrophotometric measurements of a sample by transflection and/or by transmission is suggested. It comprises a sample receiving chamber which is configured by its shape, its size, its reflective surface, and/or a surface structure of at least a portion of the reflective surface, and the material used for the reflective surface, in particular of its diffusive mirror surface which partly or fully covers the reflective surface and the geometry and/or shape of the surface of the diffusive mirror to different samples and sample geometries. The herein described reflective sample holders are compared by measure experiments to commonly available reflective gold mirrors with a similar high reflectivity. Importantly, the commonly available reflective gold mirrors are limited to planar surfaces.

Particularly, according to an embodiment a sample holder for spectrophotometric measurements of a sample using a transflection technique is suggested. Said sample holder comprises a sample receiving chamber comprising a diffusive mirror. A curvature of the diffusive mirror is adapted to a curvature of a surface of the sample and/or adapted to a curvature of a surface of a container comprising the sample.

Advantageously the herein described reflective sample holders enable an overall higher quality and an overall higher reproducibility of the measurement results. More specifically, with use of the reflective sample holder a lower signal to noise ratio, a higher spectral resolution and therefore an improved detection limit and sensitivity are achieved. Furthermore, the reproducibility of measurements is greatly improved.

According to an embodiment the suggested sample holder comprises a hollow light guiding channel. In the hollow channel a fluid inside the channel is typically ambient air or a gas but not a liquid or a solid as used typically in a light guiding fiber or in a waveguide. Different to light guiding fibers and optical waveguides, a shape of a cross-section and/or a diameter thereof varies over the length of the light-guiding channel and is adapted to the shape of the sample. The light-guiding channel partly or fully encloses the sample and/or the container. Further, the light guiding channel may be adapted as well to be optically connected to the measurement window of the spectrophotometer or a detector of the spectrophotometer, e.g. an integrating sphere inside the spectrophotometer.

Advantageously, signal losses can greatly be minimized and sensitivity of Raman and/or NIR measurements of the sample can be enhanced.

According to an embodiment the sample holder is configured for spectrophotometric measurements of a sample using a transmission technique and/or transflection technique by a hollow light guiding channel which is optically connected with the sample receiving chamber, wherein an inner wall of the hollow light guiding channel is covered by a smooth reflective coating. The light guiding channel is configured to encase at least partially a part of the sample or a part of the container containing the sample. Typically, a portion of the light guiding channel covers or is adjacently positioned along a surface of the part of the sample or of the container, more preferably along a circumferential direction of a curved surface of the sample or of the container. Further, the light guiding channel may be adapted as well to be optically connected to the measurement window of the spectrophotometer or a detector of the spectrophotometer, e.g. an integrating sphere inside or even outside the spectrophotometer.

Therein, the part of the sample and/or of the container may be tubular (e.g. with a circular cross-section).

Advantageously, the sample holder is adapted by a size and shape of its sample receiving chamber to any size or shape of a flexible or non-flexible container which contains an analyte.

According to an embodiment a shape of the sample receiving chamber is configured to receive the container comprising the sample, wherein the container either represents a primary container and single containment of the sample, i.e. is a primary container, or the container represents a secondary container which encases the primary container, wherein the sample is disposed in said primary container. Typically, the container is a closed and germ-proof container and provides a barrier against any contamination of the sample, e.g. a contamination by a liquid, a dust, a virus, and a microorganism or a spore thereof.

Advantages have been mentioned in the introduction of present application.

According to an embodiment the container comprises at least one of: a plastic, a paper, a glass, a metal, and a textile, e.g. a nonwoven; wherein the paper and the textile may optionally be coated with a polymer in order to ensure a sterility of a volume encased by the container. Optionally the plastic is selected from a thermoformed polymer film, a polymer shrink film, and a plastic film bag.

Advantageously, said container and measurement signals generated by its material do not interfere with the signals obtained from the analyte. These containers ensure the sterility of the sample, e.g. the sterility of a pharmaceutical formulation.

According to an embodiment the sample receiving chamber encases the sample completely as a whole or at least along a circumferential direction of a curved or even circular surface of the sample or container, or tubular part of the sample or container comprising same.

Advantageously, signal loss can be minimized and signal intensity be enhanced to ameliorate a sensitivity of a detection method for an analyte, e.g. a pharmaceutically active substance.

According to an embodiment an inner side of a channel wall of the light guiding channel is at least partially covered with a reflective coating, wherein the reflective coating is reflective for a light used in a measurement light beam used in the spectrophotometric measurements. Therein, a material used as the reflective coating is selected from a metal, a glass, a ceramic, and a polymer, e.g. Teflon. Typically, the reflective coating material is reflective for NIR within the used wavelength range.

According to an embodiment the sample the sample holder is adapted to or used for is selected from a crop, a fruit, a flower bud, an inflorescence, a plant extract, a plant oil, a powder or powder mixture that may be formed into a solid—such as a tablet, a pharmaceutical dosage form selected from: a tablet, a coated tablet, a suppository, a coated suppository, a hard gelatin capsule, a soft gelatin capsule, a candy, a drop, an ointment, a cream, a gel, a lotion, a dispersion, a granulate, a solution, an injection solution, an infusion solution, a liquid food—especially a liquid food intended for enteral administration.

Advantageously, these are typical dosage forms for pharmaceutically active ingredients administered to a patient.

According to an embodiment the container is selected from: a syringe, an infusion bag, a vial, a bottle, a cuvette, a blister, a hard or soft gelatin capsule, a film of a film-coated tablet, a dragée, a suppository, and a film coated suppository.

According to an embodiment at least a portion of the sample receiving chamber comprises one of: a cylinder, a tube, a sphere, a half sphere, a prolate spheroid, an oblate spheroid, an ellipsoid, an elliptic a paraboloid, a cube, a cuboid, a prism, a pyramid, a cone, a truncated cone, a hyperboloid, a parabolic, a helix, a torus, a parametric geometry, and a differential geometry.

Advantageously, a corresponding shape of the sample receiving chamber or at least of a portion thereof is adapted for an optimal fitting of the sample into the sample receiving chamber and thus an overall higher quality and an overall higher reproducibility of the measurement is achieved.

According to an embodiment a surface structure of the diffusive mirror comprises multiple geometric bodies or parts thereof, wherein the geometrical bodies are selected from: a cylinder; a tube; a sphere; a half sphere; a prolate spheroid; an oblate spheroid; an ellipsoid; an elliptic; a paraboloid; a cube; a cuboid; a prism—particularly from oblique prisms, more particularly from triangular or quadrangular or pentagonal or hexagonal oblique prisms, in particular from oblique triangular prisms. The geometrical bodies can also be selected from: pyramids—more particularly from oblique and/or straight pyramids, even more particularly from triangular, quadrangular, pentagonal or hexagonal oblique and/or straight pyramids. They can as well be selected from cones, truncated cones, hyperboloids, parabolics, a helix (or helices), and a torus (or tori). According to typical embodiments these geometrical bodies are arranged side by side, i.e. immediately adjacent to each other, or with a certain distance with respect to each other. Therein said distance can gradually vary along a row of such geometric bodies and/or their parts, wherein said rows are either arranged side by side or with a distance to each other.

According to an embodiment the sample holder further comprises an identifying element, wherein the identifying element is optically or electronically readable and configured to provide information selected from: the contained sample type (e.g. syringe or infusion bag), the sample holder ID, a length of an optical path, a type of a surface structure of the diffusive mirror (M), a diameter of a measurable sample; and/or a shape of the measurable sample.

According to an embodiment the identifying element comprises a 2D-code such as, e.g., a barcode or a QR-code; a RFID and/or a hologram.

According to an embodiment a manufacturing technique for producing the suggested sample holder is disclosed, wherein the manufacturing technique comprises at least an additive manufacturing technique selected from: a 3D printing of a wax model of at least a part of the sample holder; and applying a lost wax casting; wherein the lost wax casting comprises casting a molten metal, a molten metal alloy and/or a molten IR-reflective polymer, e.g. Teflon.

According to an embodiment the lost wax casting comprises: generating a casting mold for the part of the sample holder by embedding the 3D printed wax model, wherein the embedding may comprise providing paths for the molten wax to flow and for air to escape the casting mold. The lost wax casting further comprises covering the wax model with a mold forming material to generate a mold, wherein the mold forming material is typically selected from a silica slurry, a ceramic slip, and a stucco. The application of these techniques and a drying of the obtained green body results in obtaining a green shell. The green body/green shell is heated, burnt out and typically sintered to a solid, i.e. hard and stable mold, while the wax melts and leaves the shell and/or the mold. Subsequently the mold is used for casting by pouring a molten metal or a molten metal alloy into the mold. The mold can also be used for injection molding, e.g. with a molten polymer. Finally, the cast is freed from the mold—or released. Releasing may comprise destruction of the shell/the mold. The released (raw) cast is further finished, wherein the finishing comprises at least one of grinding, polishing, plating, electroplating and/or depositing a reflective layer, particularly a gold layer.

Advantageously, molten wax techniques are well established and can be adapted to any shape or surface structure of the elements of the suggested sample holder. Further, as stated before, gold reflects more than 95 percent of incident radiation at wavelengths above 700 nm. Therefore, less intensity of the original light beam is lost during the transflection.

According to an embodiment the additive manufacturing comprises fused deposition modelling for a plastic part of the sample holder, wherein the plastic part comprises a thermoplastic, e.g. a polylactic acid (PLA) or, e.g., an Acrylonitrile Butadiene Styrene (ABS).

Advantageously, these polymers are commercially available and easily to process.

According to an embodiment a method for analyzing a sample comprising an analyte is suggested. Said method comprises: providing a sample holder for the sample according to any of the embodiments described above and further below; arranging the sample in the sample receiving chamber of the sample holder; directing a measurement light beam into the sample receiving chamber; and collecting a transmitted and/or transflected light from the sample receiving chamber.

Advantageously, the method may be performed such that an integrity parameter of the sample such as a sterility, a volume, a composition, a color; a viscosity and/or a shelf life remains unchanged. Typically, the analyte is selected from a biologically active substance, more typically a pharmaceutically active substance and/or a contaminant thereof.

Further, the analyte is typically dispersed or dissolved in a liquid or solid sample and/or the sample typically comprises a sterile medicinal/pharmaceutical preparation, e.g. for injection.

Preferably, the analyte is a compound containing chemical bonds which are able to interfere with a NIR light beam (e.g. C—H—, O—H—, N—H-bonds) and/or may serve as a Raman scatterer (e.g. C—C—, C═C—, C—O-bonds).

Furthermore, the analyte is typically dissolved in a liquid and/or the sample typically comprises a sterile medicinal/pharmaceutical solution, e.g. for injection.

According to an embodiment the suggested method further comprises: generating and analyzing a spectrum of the collected transmitted and/or transflected light; and determining a parameter of the sample, e.g. identifying a presence of the analyte and/or a content of the analyte in the sample, a particle size, a water content.

According to an embodiment the suggested above method further comprises:
quantifying a transmitted or a transflected light, wherein the transflected light comprises a transmitted light emitted from a NIR spectrophotometer or a Raman spectrophotometer which is reflected at a diffusive mirror of the sample receiving chamber.

According to an embodiment a method for characterizing a sample for identification, detection or verification of conformity, semi-quantification or quantification of an analyte is suggested, wherein said method encompasses a measurement of a transflected and/or of a transmitted light by NIR spectrophotometry and/or by Raman spectrophotometry using the sample holder according to any of the embodiments described above and further below.

According to an embodiment of the suggested method the analyte comprises a cannabinoid selected from: cannabidiol (CBD), tetrahydrocannabinol (THC), cannabidiol Acid (CBDA), tetrahydrocannabinolic Acid (THCA), cannabinol (CBN), cannabigerol (CBG), cannabigerolic acid (CBGA), cannabidivar (CBCV), cannabichromen (CBC), cannabicyclol (CBL), cannabielsoin (CBE), cannabinodiol (CBND), cannabitriol (CBTL), cannabidivarin (CBDV) and tetrahydrocannabivarin (THCV).

Advantageously, these analytes can usually be detected in medicinal Cannabis preparations after their extraction, by HPLC and/or mass spectrometry. However, HPLC and MS require special (and expansive) laboratory equipment, and highly qualified specialists, whereas the suggested method is cheaper and at least not less sensitive/reliable.

According to an embodiment the cannabinoid is provided as a cannabis extract in a syringe, in an infusion bag, in a vial, in a bottle or in a cuvette, in a soft or hard gelatin capsule, in a suppository or in a Cannabis inflorescence, wherein the syringe, the infusion bag, the vial, the bottle, the cuvette, the soft or hard gelatin capsule, the suppository and the Cannabis inflorescence comprises an oil, a solution or a resin containing the cannabinoid.

Advantageously, these APIs according to the European pharmacopoeia need to be monitored.

According to an embodiment the analyte detected with the method previously described comprises caffeine.

Advantageously, the proposed method is simple, rugged, reliable and cheap in comparison to established methods.

According to an embodiment the analyte is dissolved in a solution, and/or the analyte is contained in a syringe, an infusion bag, a vial, a bottle, a cuvette, a dragée, a soft or hard gelatin capsule, a tablet or a film-coated tablet, or in a suppository.

Advantageously, these are typical dosage forms for many pharmaceutically active substances.

According to an embodiment the syringe, the infusion bag, the vial, the bottle, the cuvette, the dragée, the soft or hard gelatin capsule, the tablet or the film-coated tablet, and the suppository is enclosed by a secondary container.

In such event, the shape of the sample receiving chamber is adapted to a shape of the secondary container. However, typically the secondary container is made of a flexible material which will smoothly cover the primary container which holds the sample.

Each embodiment described above may be combined with any other embodiment or embodiments unless clearly indicated to the contrary.

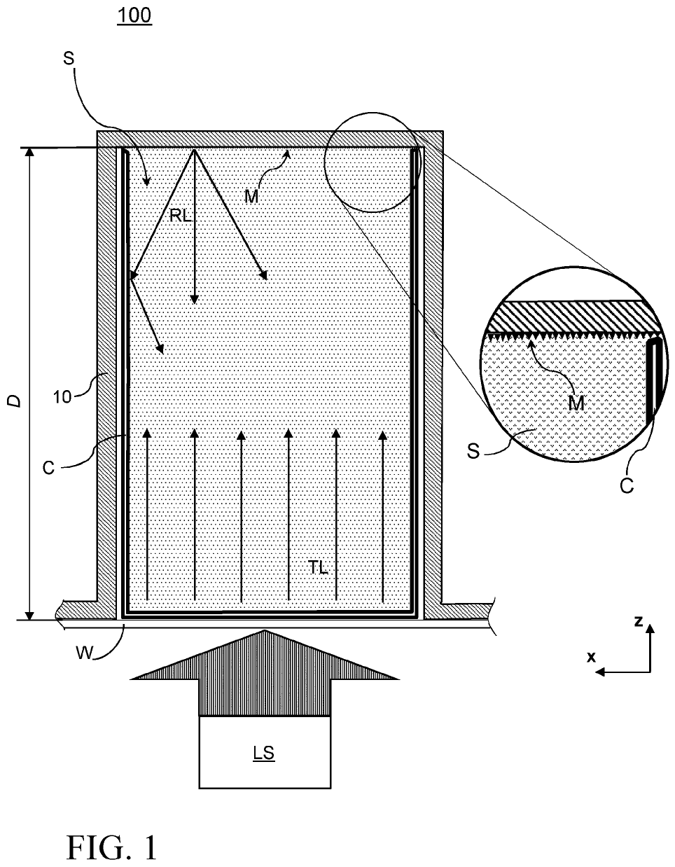

As to the illustrations, the drawing in FIG. 1 represents an embodiment 100 of a one piece cylindric sample holder 10 which is configured for measuring, e.g., a sample S comprising, e.g., dried herbs or flower buds and/or inflorescences held in a transparent container C. The sample holder 10 comprises a diffusive mirror M. The container C is placed on the measurement window W of the spectrophotometer. The container C with the sample S is covered by the bell-shaped sample holder 10. A seam (not shown) is shaped such as to center the sample holder 10 covering the container C directly over the measuring beam emitted by the light source LS of the spectrophotometer. Transmitted through the sample S light TL is reflected as reflected light RL by the diffusive mirror M and by the reflective surface of the cylindric sample holder 10 and finally arrives as transflected light in the measuring chamber of the spectrophotometer at the corresponding detector, e.g. a photoelement or an avalanche photodiode.

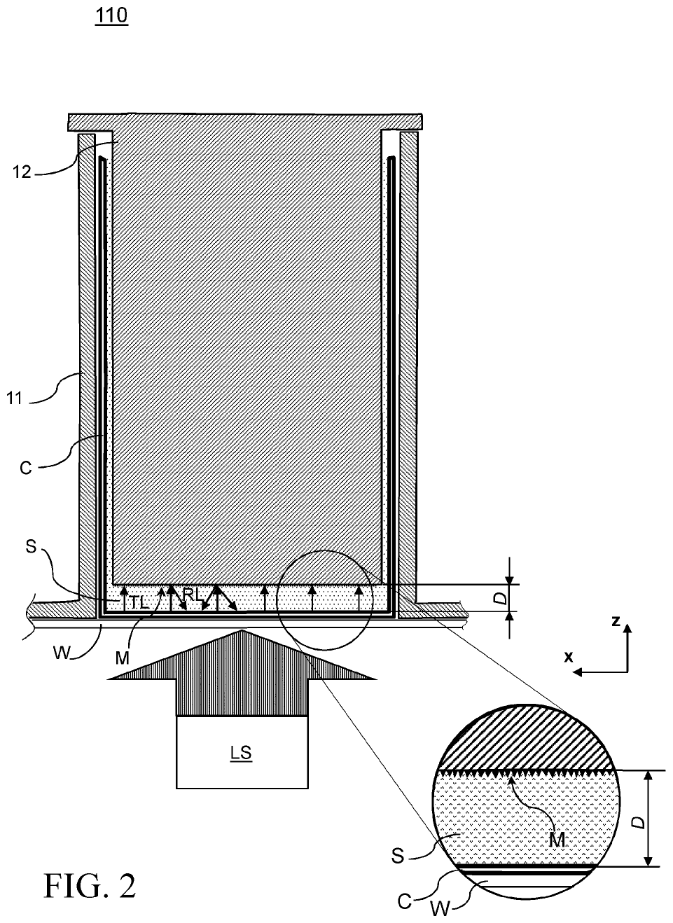

FIG. 2 shows another embodiment suitable for smaller volumes of a sample S, e.g. a liquid, a solution, a suspension, a dispersion or a gel. This type of sample holder can also be used for compressing a medicinal plant material, e.g. dried herbs or flower buds in a container C. The container C is disposed inside a tubular element 11 having an inner diffusive mirror surface. The reflectivity of the inner surface may be different from the reflectivity of the diffusive mirror M at the frontal face of the plug shaped element 12. Under the weight of the central plug-shaped element 12, the sample material S in the container C can be compressed. For that purpose, the plug-shaped element 12 is inserted into the container C containing the sample S. It includes a diffusion mirror M on its front surface. The plug-shaped element fits into the container C, which is tightly enclosed by the outer tube of the sample holder 110 having an inner reflective surface. Advantageously, a defined distance D between the wall of the container C sitting on the measuring window W and the diffusive mirror M can thus be set in a self-adjusting manner.

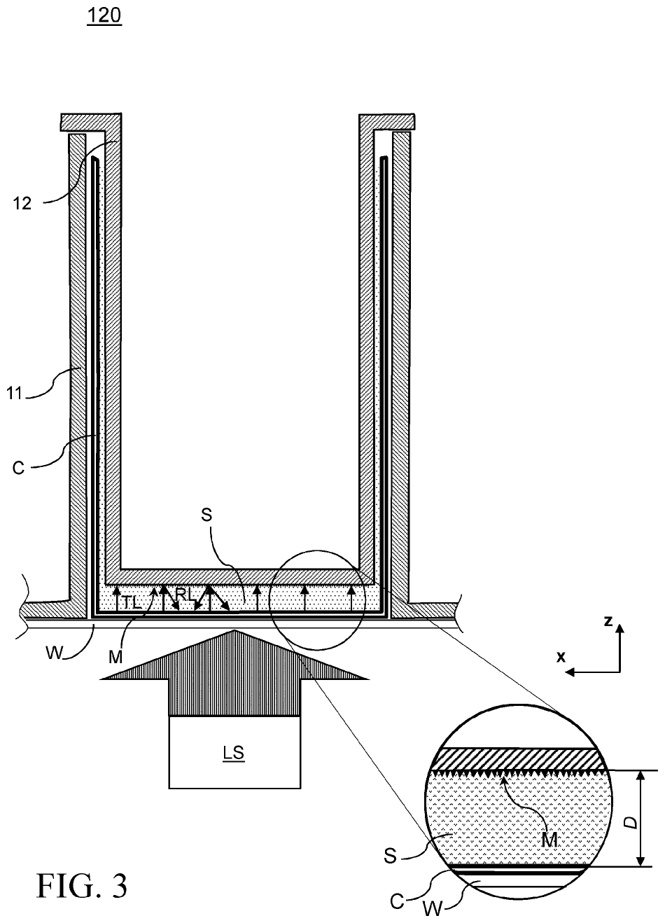

FIG. 3 shows an embodiment 120 which is a variation of the previous embodiment 110. Advantageously, the combination of an outer tube 11 with a piston-like inner element 12, which is hollow, enables a material saving.

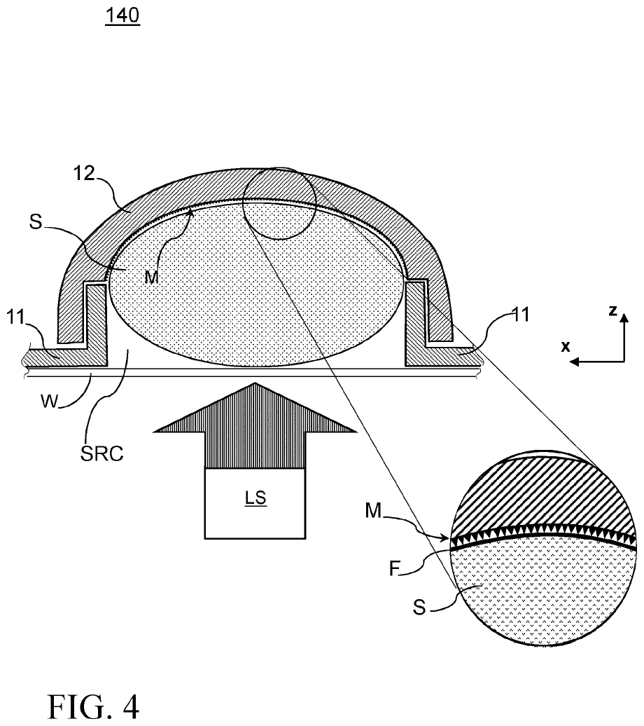

The sample holder 140 according to the embodiment shown in FIG. 4 provides a sample receiving chamber SRC which is adapted to hold a sample S, e.g. an individual soft or hard gelatin capsule, a dragée, a suppository, a tablet or a film coated tablet. The sample receiving chamber SRC is formed by a first element providing an outer barrier 11 and a second element 12 comprising a diffusive mirror M. An outer contour of the second element 12 fits optimally with an inner contour of the first element 11/or vice-versa. Advantageously, an outer rim of the second element may be shaped to close in a light-tight manner the sample receiving chamber at a side which is far from the spectrophotometer. The first element 11 and the second element 12 together form a bell-like structure resembling the sample holder according to the embodiment 100 described above.

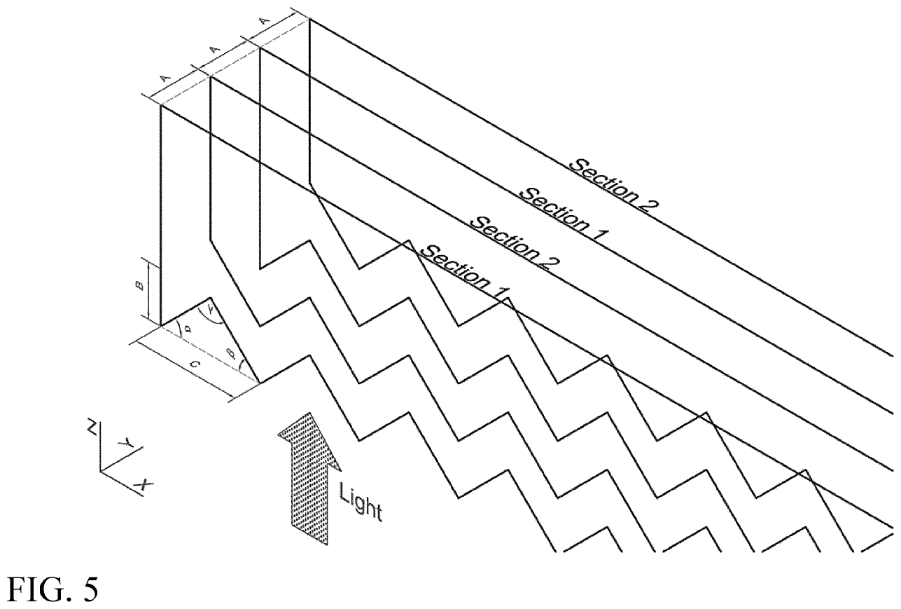

FIG. 5 shows sections which are used for the generation of a surface structure of a diffusive mirror. Typically, a section is made by the iteration of a polygon unit/module along an axis, e.g. an x-axis. In the shown figure the polygon is a triangle with the height B, the length of the Base C as well as the angles α, β and γ. A copy of the first section (Section 1) is offset for dimension A on the Axis Y and is furthermore offset on the Axis X, in order to let the top vertex of the triangles of the first section (Section 1) share the same coordinate on the Axis X as the bottom vertex of the triangles of the second section (Section 2). The described process of adding another section is repeated until the required area for the diffusive mirror is covered. The required area of the diffusive mirror is defined by the specific requirements, for example the sample's geometry. FIG. 5 shows merely an example of two periodically arranged repetitions, therefore the four shown sections. Other combinations of more sections comprising different values for A, B, and/or C and α, β and γ can be used for adapting the resulting corrugated diffusive mirror to either a curvature of the container and/or of the sample and or to a distance from a center of the sample receiving chamber and/or a central axis of the sample beam.

Expressed in other words, the reflective surface comprises a planar, a curved or a more complex surface whose curvature and shape is adapted to an outer contour or shape of the sample. It is a primary objective of said adaptation to ensure reproducible and optimal measurement conditions and ensure that a loss of intensity of the measurement light beam does primary happen due to absorption by the sample. The reflective surface comprises a 3D-pattern or 3D-micropattern, providing the surface with a pitted texture acting as diffusive mirror. The 3D-pattern is generated by lofting sections. A section is made by the iteration of a polygon unit/module, more particularly a triangle unit/module, more particularly an isosceles triangle unit/module along an axis. This axis can be a straight line, a curved line or a polyline or a spline or an irregular line (in 2D or 3D). For example, a single triangle may have a base (C) and a height (B) in a range within 0.01 to 2 mm, e.g. 2 mm base (C) and 1 mm height (B), as well as degrees for the angles α, β and γ in the range of 1 to 175 degrees, e.g. α=45°, β=45° and γ=90°. This triangle is repeated along in a row (Axis X) for a longitude defined by the position and size of the reflecting area needed, and its total length is typically adapted to the specific sample or a section thereof. Once the unit or module is repeated along this distance, the section is defined. A copy of this described section is offset by dimension A in the direction of, for example, Axis Y and then this copy is moved in Axis X in order to let the top vertex of the triangle of Section 1 share the same coordinate on Axis X as the bottom vertex of the triangle of Section 2. This results into a module in 3D that is an oblique triangular prism. The volume of such oblique triangular prisms can vary between 0,0005 mm³ and 8 mm³ more particularly between 0,005 mm³ and 1 mm³. Therefore, the resulting surfaces of the oblique triangular prism are arranged in an angle between 89 and 1 degrees, more particularly between 60 and 20 degrees towards measurement light beam. For the case in that the triangular section is adapted to for example a semicircular row, the triangle unit/module as well as the resulting oblique triangular prism and their angles are distorted.

In this context, it is self-evident for the skilled person familiar with 3D manufacturing that the described geometries are implemented and stored in a suitable control program of the 3D printer used for 3D manufacturing in the usual manner, so that exactly the described arrangements of straight, inclined, oblique, curved and/or undulating and at least partially repeating surface structures can be generated by means of the selected 3D printing technique.

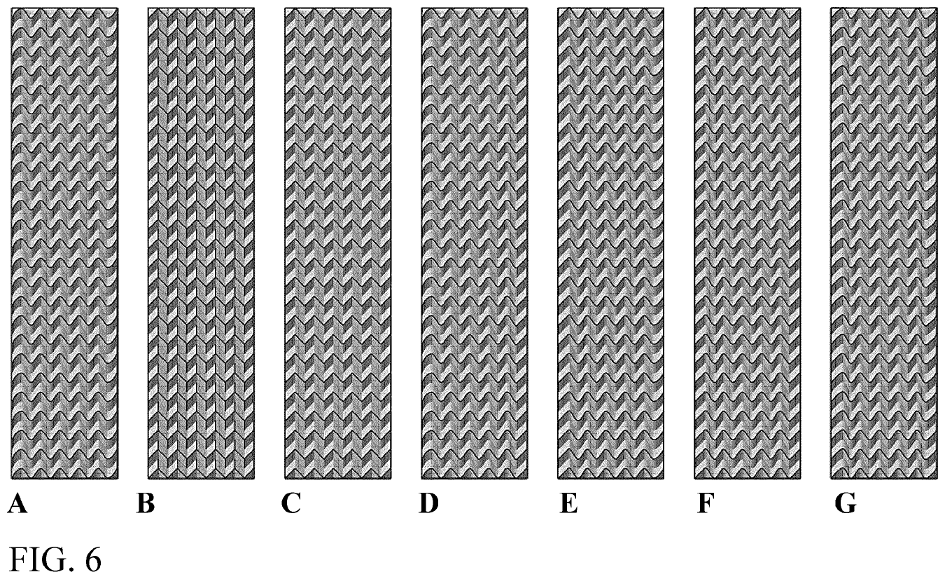

FIG. 6 shows several planar surface structures of a diffusive mirror that can be generated from the sections shown in FIG. 5. The different planar surface structures of the diffusive mirrors are generated by lofting and parametrically adapting the surface with different procedures—two points can be unified in infinite ways, which affects the result in the surface and/or pattern. Particularly, FIG. 6A shows an embodiment comprising a smooth fit;

FIG. 6B shows an embodiment with a ruled fit; FIG. C shows an embodiment comprising a normal to all sections; FIG. 6D shows an example of a normal to start section; FIG. 6E shows an example of a normal to end section; FIG. 6F shows an example of a normal to start and normal to end sections; FIG. 6G shows an example of an embodiment of the corrugated mirror surface comprising a draft angle. The repetition and mirroring of this volume as unit along the reflecting surface generates the 3D-pattern with diffusive properties. This results in a density between 500.000 and 10 per 1 cm², more particularly between 50.000 and 25 per 1 cm² on the surface of the diffusive mirror.

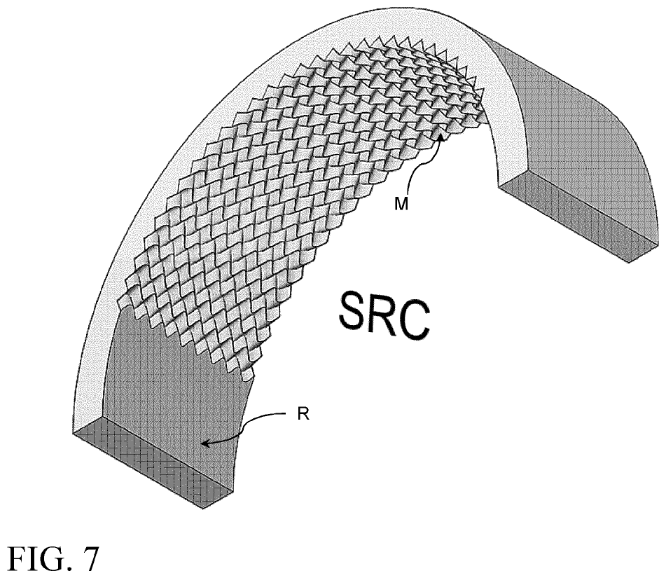

FIG. 7 shows the curved surface structure of a diffusive mirror M as well as a reflective surface obtained by a reflective coating R on a smooth portion of the mirror without such a surface structure. The shown curved surface structure of a diffusive mirror can be used for reflective sample holders which hold samples that have non-planar shapes, e.g. cylindric shapes. As indicated, the curved corrugated mirror encompasses at least a portion of the sample receiving chamber SRC.

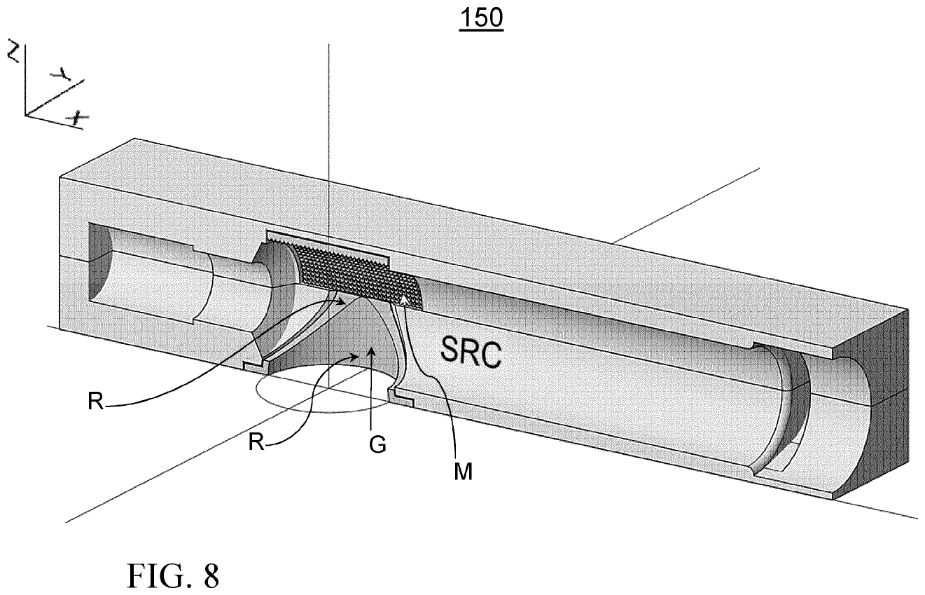

FIG. 8 shows a cross section of reflective sample holder 150 according to an embodiment for measuring a sample within a typical one-way syringe using the transflection technique. The shown reflective sample holder 150 consists of two elements: a main body and the corrugated mirror M which is connected to a light guiding channel G comprising a reflective coating R on its curved walls. Said light guiding channel has a circular cross-section at its base which is directed towards the light source of the spectrophotometer and centered with respect to the sample beam. Expressed in other words: the reflective sample holder according to embodiment 150 provides a sample receiving chamber SRC which is configured by a size and a shape of its main body to hold a sample S of cylindric shape, e g. a closed (e.g. capped) syringe that holds a sterile medicinal caffeine solution. The sample receiving chamber SRC is formed by a first functional element providing the reflectively coated surface R and a second functional element, i.e. the diffusive corrugated mirror M. An outer contour of the first functional element comprising the reflective coating fits optimally with an inner contour of the second functional element and vice-versa. Advantageously, the curved surface (its curvature) of the reflective coating R and the diffusive mirror M are adapted to the cylindric shape of the sample S in order to enable minimum loss of light intensity and maximum gain of information from the sample.

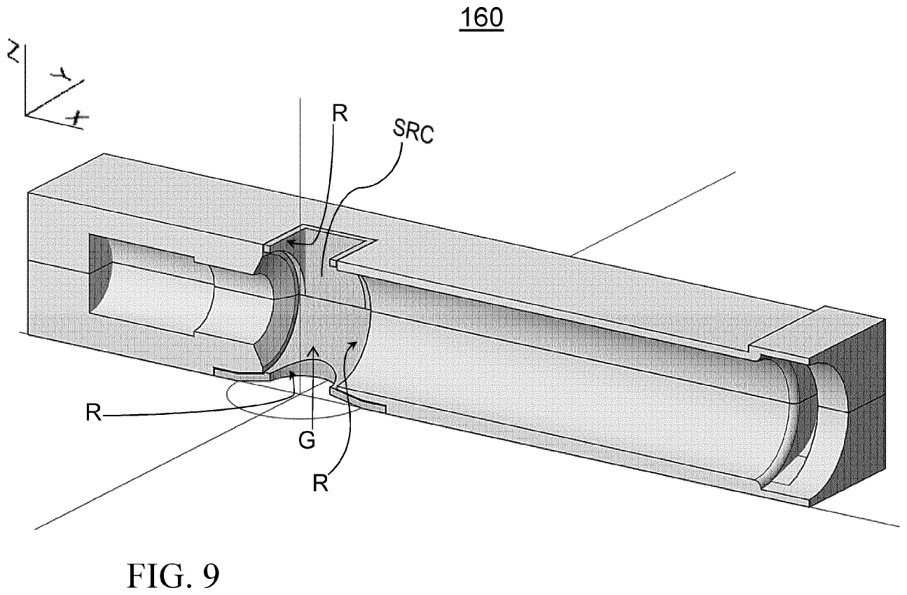

FIG. 9 shows the cross section of reflective sample holder according to another embodiment 160 for measuring a liquid contained in a syringe via transmission mode. The shown reflective sample holder 160 consists of two elements and provides a sample receiving chamber SRC which is adapted to hold a sample S of cylindric shape, e.g. a syringe that holds medicinal caffeine solution. The sample receiving chamber SRC is formed by a first functional element for guiding the incoming sample beam providing a reflectively coated surface R which is curved. Further, the sample receiving chamber of this embodiment encompasses a second functional element for guiding the outgoing measurement beam comprising a reflectively coated surface as well, wherein the reflective coating R covers planar and flat channel walls of the light guiding channel G. The outgoing sample beam (atop the main body) “carries” or comprises the signal which is characterized, e.g., by an intensity which is modulated mainly by a specific absorption and a specific scattering of the (incoming) measurement beam caused by the sample constituents. Together, both reflective surfaces represent the light guiding channel G that directs and guides the measurement light beam (sample beam) from one side of the reflective sample holder, through the sample, through the other side of the reflective sample holder. An outer contour of the second element fits optimally with an inner contour of the first element or vice-versa. Advantageously, the reflective light guiding channel G is adapted to the cylindric shape of the sample S to enable minimum loss of light intensity and maximum gain of information from the sample S.

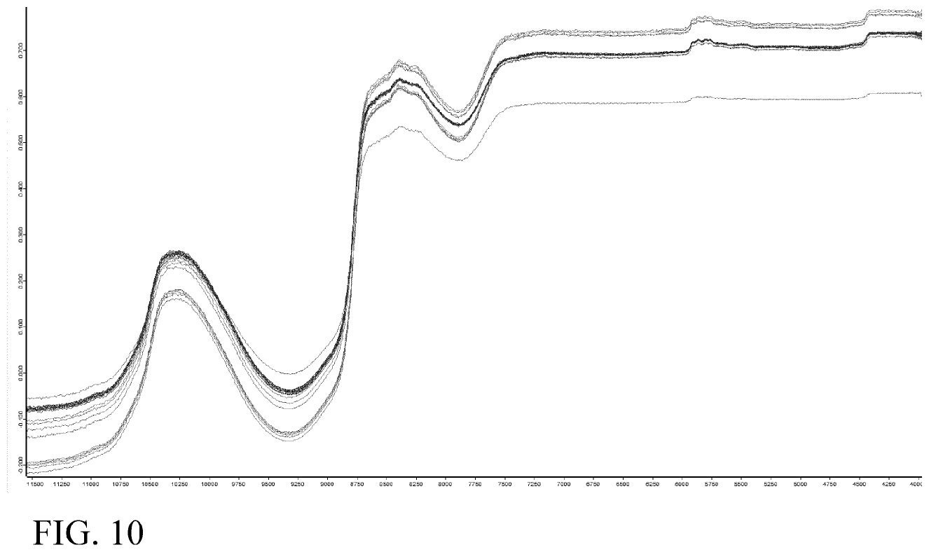

FIG. 10 shows an NIR-spectrum that contains measurements of syringes that hold medicinal caffeine solutions. These measurements were generated with the transflection technique. The blue lines show ten measurements conducted with use of the herein described reflective sample holder 150, while the red lines show ten measurements conducted without a reflective sample holder but with a commonly available reflective gold mirror. The results prove that the suggested reflective sample holder enables an overall higher quality and an overall higher reproducibility of the measurement results. The abscissa (x-axis) shows the wavelength expressed in wavenumber and the y-axis (ordinate) shows the corresponding signal intensity (absorbance)

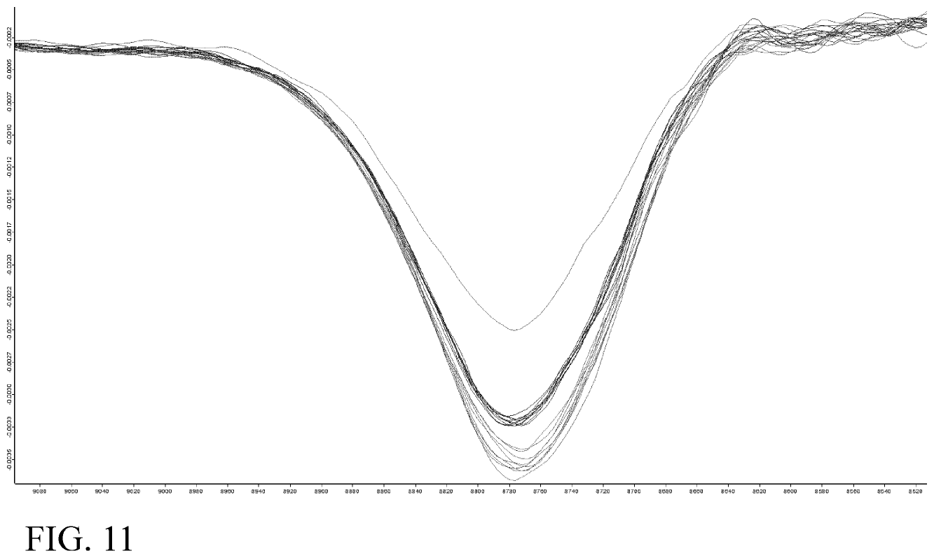

FIG. 11 shows the first derivation of a section of the NIR-spectrum shown in FIG. 10, that contains measurements of syringes that hold medicinal caffeine solutions. These measurements were generated with the transflection technique. The blue lines show ten measurements conducted with use of the herein described reflective sample holder 150, while the red lines show ten measurements conducted without a reflective sample holder but with a commonly available reflective gold mirror. The results prove that the reflective sample holder enables an overall higher quality and an overall higher reproducibility of the measurements.

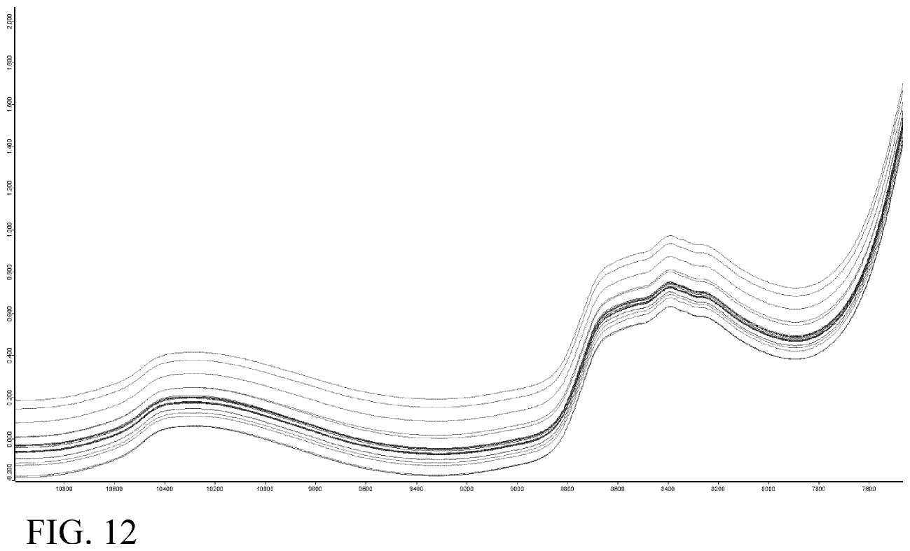

FIG. 12 shows an NIR-spectrum that contains measurements of syringes that hold medicinal caffeine solutions. These measurements were generated with the transmission technique. The blue lines show ten measurements conducted with use of reflective sample holder 160 that allow the use of the transmission technique, while the red lines show ten measurements conducted without any additional tool. The results prove that such a reflective sample holder enables an overall higher quality and an overall higher reproducibility of the measurement results.

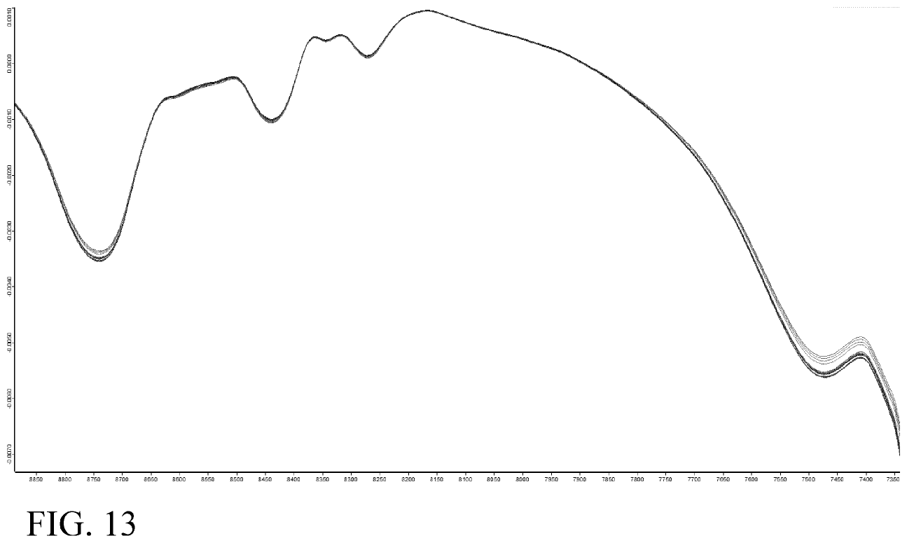

FIG. 13 shows the first derivation of a section of the NIR-spectrum shown in FIG. 12, that contains measurements of syringes that hold medicinal caffeine solutions. These measurements were generated with the transmission technique. The blue lines show ten measurements conducted with use of reflective sample holder 160 that allow the use of the transmission technique, while the red lines show ten measurements conducted without any additional tool. The results prove that such a reflective sample holder enables an overall higher quality and an overall higher reproducibility of the measurement results.

Summarizing, a sample holder (100, 110, 120, 140, 150) for spectrophotometric measurements of a sample (S) using a transflection technique is suggested, the sample holder comprising a sample receiving chamber (SRC) comprising a diffusive mirror (M), wherein a curvature of the diffusive mirror (M) is adapted to a curvature of a surface of the sample (S) and/or adapted to a curvature of a surface of a container (C) comprising the sample (S). Further, a sample holder (160) for spectrophotometric measurements of a sample (S) using a transmission technique is suggested, the sample holder comprising a hollow light guiding channel (G), wherein an inner wall of the hollow light guiding channel (G) is covered by a smooth reflective coating (R) and is configured to encase at least partially a tubular part of the sample (S) or of a container (C) containing the sample (S) along a circumferential direction of the tubular part of the sample (S) or of the container (C). Further, a combination of manufacturing techniques for producing the sample holder is disclosed, wherein the combination comprises an additive manufacturing comprising 3D printing of a wax model of at least a part of the sample holder; and applying a lost wax casting; wherein the lost wax casting comprises casting a molten metal, a molten metal alloy and/or a molten IR-reflective polymer. Furthermore, a method for analyzing a sample comprising an analyte is suggested, wherein the method comprises: providing the sample holder for the sample; arranging the sample in the sample receiving chamber (SRC) of the sample holder; directing a measurement light beam into the sample receiving chamber (SRC); and collecting a transmitted and/or transflected light from the sample receiving chamber (SRC). Finally, a method for characterizing a sample for identification, conformity, semi-quantification and quantification of an analyte is disclosed, the method comprising measurement of a transflected and/or transmitted light by a NIR spectrophotometry and/or by a Raman spectrophotometry using the sample holder.

The described embodiments have versatile application areas for the detection of pharmaceutical substances, possible contaminants thereof and/or adulterants or their degradation products, e.g. as a result of incorrect storage conditions in the area of pharmaceutical, medical, veterinarian or biochemical application of biologically active substances but also in food, e.g. food additives, concentrates etc., and convenience products. With the aim to demonstrate the feasibility of suggested embodiments, some examples describing the used apparatus and method are provided and illustrated by the attached drawings.

The present invention has been explained with reference to various illustrative embodiments and examples. These embodiments and examples are not intended to restrict the scope of the invention, which is defined by the claims and their equivalents. As is apparent to one skilled in the art, the embodiments described herein can be implemented in various ways without departing from the scope of what is invented. Various features, aspects, and functions described in the embodiments can be combined with other embodiments.

### REFERENCE SIGNS

10 one piece cylindric shaped reflective sample holder
11 first element of reflective sample holder
12 second element of reflective sample holder
100 embodiment of reflective sample holder
110 embodiment of reflective sample holder
120 embodiment of reflective sample holder
140 embodiment of reflective sample holder
150 embodiment of reflective sample holder
160 embodiment of reflective sample holder
C container
D thickness
F film or coating (e.g. of a capsule)
G light guiding channel
LS light source
M diffusive mirror
R reflective coating
RL reflected light
S sample
SRC sample receiving chamber
TL transmitted light
W measurement window of spectrophotometer

In the clauses attached below following reference signs are used according to the Figures of the priority application PCT/EP2021/069213, the disclosure of which is incorporated in its entirety by reference in the present application.
1 spectrophotometer (NIR- or Raman-spectrophotometer)
2 liquid, e.g. a biologically active substance, a drug, a vaccine, a food additive
3 polymer container (infusion bag, pump or disposable plastic syringe, optionally packaged)
3a tubular section of polymer container
3b corner of polymer container, esp. of infusion bag
4 sterile package (typically made from a polymer foil) optical element, e.g. mirror or light guide
6 channel, e.g. light guiding channel
66 abutment, tongue of holder 13
7 container holder
8 lid
87 lip, channel flange
88 opening in light-tight box
9 light-tight box
10 measurement chamber extension
11 adapter
11′ adapter opening
13 receptacle, holding member for tubular part
15 mirror fixing member
20 measurement chamber
40 bag orienting member
41 outer contour of bag orienting member

### Clauses

1. A measurement chamber extension (10) for a spectrophotometric characterization with a NIR-spectrophotometer (1) or a Raman-spectrophotometer (1) of a liquid (2) in a polymer container (3), wherein the measurement chamber extension (10) comprises:
   an adapter plate (11) having an adapter opening (11′);
   a container holder (7); and
   an optical element (5), selected from a mirror and a waveguide;
   wherein the adapter (11) is configured to cover in a light-tight manner the measurement chamber (20) of the NIR-spectrophotometer (1) or of the Raman-spectrophotometer (1) and the adapter opening (11′) is arranged to encompass a measurement window of the NIR-spectrophotometer (1) or Raman-spectrophotometer (1) to provide exposition of the liquid (2) to a measurement light beam emitted from the measurement chamber (20) of the NIR-spectrophotometer (1) or Raman-spectrophotometer (1) through the measurement window;
   wherein the container holder (7) is configured to allow a close placement of the optical element (5) adjacent to the polymer container (3) containing the liquid (2) providing a loss-free transmission or transflection of the measurement light beam from the optical element (5) to a detector of the NIR-spectrophotometer (1) or Raman-spectrophotometer (1); and wherein the container holder (7) comprises a clamp (13) which is configured to hold a tubular section (3a) of the polymer container (3) as to allow a reproducible measurement condition.
2. The measurement chamber extension (10) according to clause 1, wherein the container holder (7) comprises an optical element support structure comprising a channel (6), wherein a width of the channel (6) is adapted to fit with a width of the measurement window of the NIR-spectrophotometer (1) or Raman-spectrophotometer (1).
3. The measurement chamber extension (10) according to clause 2, wherein the optical element (5) comprises a mirror comprising a gold layer or at least one optical fiber or waveguide.
4. The measurement chamber extension (10) according to clause 3, wherein the optical element (5) comprises a mirror (5) and the container holder (7) comprises a receptacle (13) formed by the channel (6) together with the mirror (5).
5. The measurement chamber extension (10) according to clause 4, wherein a surface (66) of the channel (6) is covered with a gold layer.
6. The measurement chamber extension (10) according to clauses 4 or 5, wherein the container holder (7) is encased by a light-tight box (9) which optionally comprises a lid (8), wherein the lid (8) is adapted to close the light-tight box (9) in a light-tight manner.
7. The measurement chamber extension (10) according to clause 6, wherein the optical element (5) is fixed to the lid (8).
8. The measurement chamber extension (10) according to clause 5, wherein the gold layer on the surface (66) of the channel (6) merges with the gold layer of the mirror (5) and the mirror (5) is integrated with the channel (6).
9. The measurement chamber extension (10) according to any of preceding clauses, wherein the mirror (5) is a diffusive mirror (5).
10. The measurement chamber extension (10) according to clause 9, wherein the gold layer encompasses multiple mirrors (55), each mirror (55) comprising a flat polygonal face, wherein the mirrors (55) are arranged as a corrugated surface of the mirror (5).
11. The measurement chamber extension (10) according to clause 10, wherein the surface of the mirror (5) comprises a rough or smooth surface.
12. The measurement chamber extension (10) according to clause 10 or 11, wherein the corrugated surface of the mirror (5) has a roughness in a range of 20 μm-1000 μm.
13. The measurement chamber extension (10) according to any of clauses 1-3, wherein the optical element (5) is a waveguide.
14. The measurement chamber extension (10) according to clause 13, where on the measurement window of the spectrophotometer (1) a first waveguide is positioned guiding a measuring light from a light source of the spectrophotometer (1) to the liquid (2) within the polymer container (3) and to the optical element (5), i.e. a second waveguide (5) which is configured to guide the measuring light after its passage of a layer of the liquid (2) within the polymer container (3) from the polymer container (3) to a photodetector of the spectrophotometer (1).
15. The measurement chamber extension (10) according to any of preceding clauses, wherein the polymer container is a disposable syringe (3).
16. The measurement chamber extension (10) according to clause 15, wherein the light guide (6) comprises a channel (6), wherein an end of the channel (6) is shaped into a tongue (66) which forms a receptacle (13) for fitting and holding a tubular section (3a) of the syringe (3) in an orthogonal orientation relative to a central axis of the channel (6), wherein a surface of the tongue (66) which is oriented substantially towards the channel (6) comprises a corrugated surface (55) comprising the mirror (5), and the circular section (3a) of the syringe (3) is arrangeable in the receptacle within a light path of the sample beam.
17. The measurement chamber extension (10) according to any of clauses 15 or 16, wherein the syringe (3) is enclosed by a sterile package (4).
18. The measurement chamber extension (10) according to any of clauses 1 through 5, wherein the adapter opening (11′) is adapted to accommodate a corner (3b) of an infusion bag (3).
19. The measurement chamber extension (10) according to clause 18, further comprising a bag orienting member (40), wherein an outer contour (41) of the bag orienting member (40) is configured to fit over a major part of an outer contour length with an inner contour of the adapter opening (11′), if the bag orienting member (40) is at least partially inserted into the adapter opening (11′).
20. The measurement chamber extension (10) according to clause 19, wherein corresponding pairs of permanent magnets are arranged at or near to fitting edges of the adapter opening (11′) and the bag orienting member (40).
21. The measurement chamber extension (10) according to any of clauses 18-20, wherein a thickness of a layer of the liquid (2) in the bag (3) is adjustable between 0.2 mm-5.1 mm, preferably adjustable at 0.5-2.1 mm.
22. The measurement chamber extension (10) according to any of clauses 18-21, wherein the mirror (5) is fixable by a mirror fixing member (15).
23. The measurement chamber extension (10) according to clause 22, wherein the mirror fixing member (15) and the bag orienting member (40) comprise at least one magnet of a pair of permanent magnets for stabilization of the mirror within the channel (6), wherein the channel (6) is dimensioned to encompass the mirror (5).
24. A method for analyzing with a NIR-spectrophotometer (1) or a Raman-spectrophotometer (1) a liquid (2) in a polymer container (3) selected from: an infusion bag (3), a syringe (3), or a syringe (3) enclosed in a sterile package (4), by using a measurement chamber extension (10) according to any of clauses 1-23, the method comprising:
   holding a circular part (3a) of the polymer container (3) by a receptacle (13);
   arranging the optical element (5) of the measurement chamber extension (10) adjacent to a surface of the polymer container (3);
   directing a measurement light beam towards the optical element (5) and analyzing a transmitted or a transflected light with a spectrophotometer (1), selected from a NIR-spectrophotometer (1) and a Raman-spectrophotometer (1);
   comparing a signal generated by the transmitted or transflected light with a data set stored in a data base comprising NIR-spectra or Raman-spectra of similar or identical samples;
   determining an identity of a solute dissolved or particles/liquid dispersed in the liquid (2) and/or detecting an adulterant or contaminant in the liquid (2); or
   determining a quantity of a solute dissolved or particles/volume dispersed in the liquid (2) and/or detecting an adulterant or contaminant in the liquid (2); and/or
   determining a physical property (e. g. particle size, agglomeration) of a solute dissolved in the liquid (2) or particles dispersed/volume of liquid (2) and/or detecting an adulterant or contaminant in the liquid (2).
25. The method according to clause 24, wherein the measurement light beam comprises light within a wavenumber range of 4,000 cm-1-12,500 cm⁻¹.
26. The method according to clause 24 or 25, wherein in consecutive measurements sample beams of different wavelengths are directed towards the optical element (5), and/or measurement light beams are directed under different angles towards the optical element (5).
27. The method according to any of clauses 26-28, wherein the database comprises datasets belonging to different sample types including typical product ranges of material in the polymer container and/or the sterile package (4) of the syringe (3).
28. The method according to clause 27, wherein a software of the NIR-spectrophotometer (1) or of the Raman-spectrophotometer (1) or in a control unit thereof is adapted to extract from a measured NIR- or Raman-spectrum the corresponding spectrum belonging to the material comprising the polymer container (3) or the sterile package (4) of the syringe (3).

1-23. (canceled)

24. A sample holder for spectrophotometric measurements of a sample using a transflection technique, the sample holder comprising:
a sample receiving chamber comprising a diffusive mirror, wherein a curvature of the diffusive mirror is adapted to a curvature of a surface of the sample and/or adapted to a curvature of a surface of a container comprising the sample.

25. The sample holder according to claim 24, wherein the sample holder comprises a hollow light guiding channel, wherein an inner wall of the hollow light guiding channel is covered by a smooth reflective coating and is configured to encase at least partially a part of the sample or of a container containing the sample along a circumferential direction of the tubular part of the sample or of the container.

26. A sample holder for spectrophotometric measurements of a sample using a transmission technique, the sample holder comprising:
a hollow light guiding channel, wherein an inner wall of the hollow light guiding channel is covered by a smooth reflective coating and is configured to encase at least partially a part of the sample or of a container containing the sample along a circumferential direction of the tubular part of the sample or of the container.

27. The sample holder according to claim 24, wherein a shape of the sample receiving chamber is configured to receive the container comprising the sample, wherein the container either represents a primary container and single containment of the sample, and may comprise a secondary container which encases a primary container, wherein the sample is disposed in said primary container.

28. The sample holder according to claim 24, wherein the container comprises at least one of: a plastic, a paper, a glass, a metal and a textile, wherein the paper and the textile may optionally be coated with a polymer, and wherein the plastic is selected from a thermoformed polymer film, a polymer shrink film, and a plastic film bag.

29. The sample holder according to claim 24, wherein the sample receiving chamber encases the sample completely or at least along a circumferential direction of a tubular part of the sample.

30. The sample holder according to claim 25, wherein the light guiding channel is covered with a reflective coating, wherein the reflective coating is reflective for a light used in a measurement light beam.

31. The sample holder according to claim 24, wherein the sample is selected from a crop, a fruit, a flower bud, an inflorescence, a plant extract, a plant oil, a powder or powder mixture that may be formed into a solid—such as a tablet, a pharmaceutical dosage form selected from: a tablet, a coated tablet, a suppository, a coated suppository, a hard gelatin capsule, a soft gelatin capsule, a candy, a drop, an ointment, a cream, a gel, a lotion, a dispersion, a granulate, a solution, an injection solution, an infusion solution, a liquid food—especially a liquid food intended for enteral administration.

32. The sample holder according to claim 24, wherein the container is selected from: a syringe, an infusion bag, a vial, a bottle, a cuvette, a blister, a hard or soft gelatin capsule, a film of a film-coated tablet, a dragée, a suppository, and a film coated suppository.

33. The sample holder according to claim 24, wherein at least a portion of the sample receiving chamber comprises one of:
a cylinder, a tube, a sphere, a half sphere, a prolate spheroid, an oblate spheroid, an ellipsoid, an elliptic a paraboloid, a cube, a cuboid, a prism, a pyramid, a cone, a truncated cone, a hyperboloid, a parabolic, a helix, a torus, a parametric geometry, and a differential geometry.

34. The sample holder according to claim 24, wherein a surface structure of the diffusive mirror comprises multiple geometric bodies or parts thereof, wherein the geometrical bodies are selected from: a cylinder, a tube, a sphere, a half sphere, a prolate spheroid, an oblate spheroid, an ellipsoid, an elliptic, a paraboloid, a cube, a cuboid, a prism, a pyramid, a cone, a truncated cone, a hyperboloid, a parabolic, a helix, and a torus.

35. A combination of manufacturing techniques for producing a sample holder according to claim 24, wherein the combination comprises an additive manufacturing comprising:
3D printing of a wax model of at least a part of the sample holder; and
applying a lost wax casting;
wherein the lost wax casting comprises casting a molten metal, a molten metal alloy and/or a molten IR-reflective polymer.

36. The combination of manufacturing techniques according claim 35, wherein the lost wax casting comprises:
generating a casting mold for the part of the sample holder by embedding the 3D printed wax model;
covering the wax model with a mold forming material to generate a mold, wherein the mold forming material is selected from a silica slurry, a ceramic slip, and a stucco; and drying of the resulting green shell;
burnout and sintering of the green shell to the mold, while the wax melts and leaves the shell and or the mold;
casting by pouring a molten metal or metal alloy into the mold;
releasing the cast; and
finishing the cast, wherein finishing comprises at least one of grinding, polishing, plating, electroplating and/or depositing a reflective layer, particularly a gold layer.

37. The combination of manufacturing techniques according to claim 35, wherein the additive manufacturing comprises fused deposition modelling for a plastic parts of the sample holder, wherein the plastic part comprises a thermoplastic, e.g. a polylactic acid, an Acrylonitrile Butadiene Styrene.

38. A method for analyzing a sample comprising an analyte, the method comprising:
providing a sample holder for the sample according to claim 24;
arranging the sample in the sample receiving chamber of the sample holder:
directing a measurement light beam into the sample receiving chamber; and
collecting a transmitted and/or transflected light from the sample receiving chamber.

39. The method according to claim 38, further comprising
generating and analyzing a spectrum of the collected transmitted and/or transflected light; and
determining a parameter of the sample, e.g. identifying a presence of the analyte and/or a content of the analyte in the sample, a particle size, a water content.

40. The method according to claim 38, further comprising:
quantifying a transmitted or a transflected light, wherein the transflected light comprises a transmitted light emitted from a NIR spectrophotometer or a Raman spectrophotometer which is reflected at a diffusive mirror of the sample receiving chamber.

41. A method for characterizing a sample for identification, conformity, semi-quantification and quantification of an analyte, the method comprising a measurement of a transflected and/or transmitted light by a NIR spectrophotometry and/or by a Raman spectrophotometry using a sample holder according to claim 24.

42. The method according to claim 38, wherein the analyte comprises a cannabinoid selected from: cannabidiol (CBD), tetrahydrocannabinol (THC), cannabidiol Acid (CBDA), tetrahydrocannabinolic Acid (THCA), cannabinol (CBN), cannabigerol (CBG), cannabigerolic acid (CBGA), cannabidivar (CBCV), cannabichromen (CBC), cannabicyclol (CBL), cannabielsoin (CBE), cannabinodiol (CBND), cannabitriol (CBTL), cannabidivarin (CBDV) and tetrahydrocannabivarin (THCV).

43. The method according to claim 42, wherein the cannabinoid is contained in a cannabis extract in a syringe, in an infusion bag, in a vial, in a bottle or in a cuvette, in a soft or hard gelatin capsule, in a suppository or in a Cannabis inflorescence, wherein the syringe, the infusion bag, the vial, the bottle, the cuvette, the soft or hard gelatin capsule, the suppository and the Cannabis inflorescence comprises an oil, a solution or a resin containing the cannabinoid.

44. The method according to claim 38, wherein the analyte comprises caffeine.

45. The method according to claim 38, wherein the analyte is dissolved in a solution, and/or the analyte is contained in a syringe, an infusion bag, a vial, a bottle, a cuvette, a dragée, a soft or hard gelatin capsule, a tablet or a film-coated tablet, or in a suppository.

46. The method according to claim 45, wherein the syringe, the infusion bag, the vial, the bottle, the cuvette, the dragée, the soft or hard gelatin capsule, the tablet or the film-coated tablet, and the suppository is enclosed by a secondary container.
